(19) United States
(12) Patent Application Publication
(10) Pub. No.: US 2018/0319674 A1
(43) Pub. Date: Nov. 8, 2018

(54) REMOVAL OF SELENOCYANATE FROM INDUSTRIAL WATER SYSTEMS WITH SULFIDED METAL ADSORBENTS

(71) Applicant: UOP LLC, Des Plaines, IL (US)

(72) Inventors: Rashmi Patwardhan, Long Grove, IL (US); Jon E. Ball, Crystal Lake, IL (US); Kiran Bollapragada, Pune (IN); Stephen R. Caskey, Lake Villa, IL (US)

(21) Appl. No.: 15/586,585

(22) Filed: May 4, 2017

(51) Int. Cl. C02F 1/28

(52) U.S. Cl. CPC C02F 1/281; C02F 2101/106; C02F 1/288

(57) ABSTRACT

The invention provides a bound sulfided metal containing metals such as nickel, cobalt, iron manganese or zinc for removing selenocyanate from aqueous streams. The binder may be alumina, silica, clay or metal oxide. The amount of sulfur in the bound sulfided metal may range from 5-75% by weight. In one embodiment, the bound sulfided metal is formed and reduced and placed in a column system that comprises one or more columns and may comprise a Lead-Lag1-Lag2-Polisher series of columns.

### FIELD OF THE INVENTION

The present invention relates to a method for removing selenium from aqueous streams. More specifically, the present invention relates to a method for removing selenium from wastewater effluent, and still more specifically, to a method for removing selenium from petroleum refining wastewater. The method is especially useful for removing selenium from streams from refinery sour water strippers.

### BACKGROUND OF THE INVENTION

Selenium is a naturally occurring element that can occur in several oxidation states. It can exist in the [−II] (selenide), [0] (elemental selenium), [+IV] (selenite), and [+VI] (selenate) oxidation states. Selenium is an essential element required in trace quantities for synthesizing antioxidant enzymes which are subsequently used for preventing cell damage. However, ingestion of high selenium concentration consistently can be toxic. Higher quantities of selenium in the water is damaging to aquatic life. Selenium is often associated with sulfur due to their close resemblance and hence found along with sulfur. Fossil fuels from certain regions contain high amounts of sulfur and consequently selenium with it. During the processing of crude oil, selenium is converted to selenocyanate and is found exclusively in stripped sour water as selenocyanate. Mining industries utilizing cyanide for extraction of precious metals also generate selenocyanate in process water or leachate. Coal gasification industries also contain selenocyanate in their process water system.

It is desirable to treat these process waters before going to activated sludge treatment due to significantly lower flow rate. The flow rate of the stripped sour water is anywhere from ⅕ to 1/10 of what is commonly found after activated sludge treatment unit. Discharge of selenium is regulated in many countries. In the United States discharge regulation are getting stringent and many times it is 5 ppb or lower as total selenium. There is a need to remove selenium from processing water effectively and at lower cost without adding complexity to the water treatment system to meet the stringent requirements. Selenium is a ubiquitous element having an average concentration of about 0.7 ppm in the earth's crust, sulfur deposits, sulfide minerals of copper and molybdenum, and fossil fuels. As a result, selenium can be found in waste streams from copper refining, acid coal mine drainage, coal-fired power plants, and petroleum refining. Selenium is generally considered to be hazardous, and selenium disposal is regulated.

A particularly acute problem of selenium discharge occurs in the waste waters from petroleum refineries. Many refineries have this problem, to a lesser or greater extent depending on the origin of the crude oil. As the selenium is isomorphous with sulfur, it accompanies sulfur in the processing of the oil. Most of the sulfur and selenium found in crude ends up in refinery sour water streams which are subsequently treated by sour water strippers. However, while the stripping of hydrogen sulfide from sour water in conventional sour water strippers is highly efficient, significant amount of selenium compounds remains in the stripped sour water. The predominant selenium compound remaining in the stripped sour water is selenocyanate. Minor amounts of elemental selenium and oxidized forms such as selenite and selenate might also be present. Typically the stripped sour water, containing selenium compounds, is directed for further treatment with the rest of the refinery wastewater in the activated sludge treatment process it gets oxidized to selenite and selenates and minor amounts of other selenium species.

Sour water is process water recovered from petroleum or hydrocarbon streams during refinery operations. For example, sour water may be recovered from the petroleum streams, as in crude oil dewatering, it may be recovered from a washing process, such as during crude oil desalting, or from hydrotreating process, such as, for example, removing sulfur and nitrogen compounds from hydroprocessed products. Sour water generally contains soluble oil and free oil contaminants, inorganic ions such as ammonia, hydrogen sulfide, sodium, sulfates, sulfites, and chlorides.

Sour water is typically processed in a sour gas stripper. A sour gas stripper is a single or multi-stage separation zone for treating sour water. The stripping action may be facilitated by the introduction of a hot gaseous stripping medium, such as steam. The overhead stream from the sour gas stripper may include ammonia, hydrogen sulfide, purified water vapor, or combinations thereof, depending on the particular process. The bottoms product from the stripper is a stripped sour water stream. The stripped sour water stream generally contains the majority of the selenium compounds. Efforts to remove the selenium from a sour water stream were limited so far due to system complexity and cost. Effluents of sour water strippers are difficult to treat for selenium removal because of the unpredictable nature and unpredictable quantities of contaminants that are present in the effluents. These contaminants often hinder irreversibly selenium removal processes that use membrane, ion exchange resins or inorganic adsorbents. The method of the present invention is especially useful for removing selenium from stripped sour water. However, any aqueous stream may be usefully treated using the present method.

The success of the adsorption methods depend largely on the selenium species present and on competing ions in the water.

The present invention quantitatively, and inexpensively, removes selenium from stripped sour water prior to combining the stripped sour water with other refinery wastewater for further processing.

As noted previously, the method of the present invention is especially effective with respect to the removal of selenium from the stripped sour water effluent produced from petroleum refineries, although it is useful with other industrial effluent waters as well. Industrial processes that produce water that requires treatment include synfuel from coal conversion and many metallurgical processes where cyanide is used for metal extraction, particularly precious metals.

Current methods for removing selenium from stripped sour water involve ion exchange resin. In these methods, the selenium-containing sour water passes over an ion exchange resin, which removes selenium. While this method is effective, ion exchange resins are very expensive. Further, their use in this service is severely limited due to the presence of interfering anions such as sulfates resulting in the need for frequent regeneration resulting in higher cost and generation and disposal of concentrated regenerant containing selenium.

A review of the current methods of removing selenium, including selenocyanates reveals that improvements in the technology are needed. One of the selenocyanate treatment systems developed by Philipp's (U.S. Pat. No. 7,964,093 and U.S. Pat. No. 7,419,606) involved a carbon based adsorbent impregnated with sulfur. However, this system is very complex involving adjusting the pH of the influent to less than 3, followed by raising the temperature (60° to 80° C.) prior to treatment with the adsorbent. After the adsorbent treatment, the pH needs to be raised again before discharging it to wastewater treatment system. Another treatment system utilizes addition of salts of copper, tin or silver to the stripped sour water or generating in-situ cuprous ion followed by precipitation and solid/liquid separation unit process (U.S. Pat. No. 6,214,238). This method often requires overdosing with the respective metal salt to completely remove selenocyanate resulting in excess of the metal ions into the treated water which could have the side effect of being toxic. Attempts have been made with transition metal exchanged Y-zeolite for removal of selenocyanate but these have fairly low adsorption capacity and are unable to achieve the required limit for removal (U.S. Pat. No. 5,264,133). Treatment with quaternary ammonium compound containing ion exchange resins has also been attempted (U.S. Pat. No. 7,282,152 and U.S. Pat. No. 5,855,789). However, these systems would require very frequent regeneration resulting in higher total costs. Biological treatment systems have also been utilized but the water needs to be treated with an oxidant to convert selenocyanate to selenate and selenite prior to anoxic biological treatment to convert these oxyanions to insoluble elemental selenium. These systems can also be very costly due to need for chemicals/oxidants and various treatment units.

Oxidation methods to convert selenocyanate to selenite have been attempted. The selenite can be reacted with metal oxide, metal hydroxide, or metal salts to form the precipitate followed by any of the solid/liquid separation methods have been attempted (U.S. Pat. No. 5,993,667). These methods are quite expensive and laborious. Oxidation of selenocyanate to selenite followed by bioconversion of selenite to insoluble elemental Se has also been attempted (US 2012/0024798). The insoluble elemental selenium and the sludge can be separated easily by any of the solid/liquid separation method.

### SUMMARY OF THE INVENTION

The present invention involves a product which is a bound sulfided metal. The metal sulfides can include metals such as nickel, copper, cobalt, iron, and manganese, zinc, and many other metals from 5-95% as metal by weight. The binder system can be alumina, silica, clay, an organic binder or a metal oxide. A sulfided form of a nickel based product has shown superior performance than many other sulfur containing products but other sulfided forms can also be used. The amount of sulfur in these products can vary from 5-75% by weight. The treatment with these for removal of selenocyanate requires no pH adjustments nor does it need any heating of the water prior to treatment. It is a single use product and should be disposed off after it is saturated or exhausted. Testing results demonstrate that the product used in the present invention has very high capacity and is stable in water.

### DETAILED DESCRIPTION OF THE INVENTION

The present invention involves a product which is a bound sulfided metal. The metal sulfides can include metals such as nickel, copper, cobalt, iron, manganese, zinc and many other metals from 5-95% as metal by weight. The binder system can be alumina, silica, clay, organic binders or other metal oxides. A sulfided form of a nickel based product has shown superior performance than many other sulfur containing products but other sulfided forms can also be used. The amount of sulfur in these products can vary from 5-75% by weight. The treatment with these for removal of selenocyanate requires no pH adjustments nor does it need any heating of the water prior to treatment. It is a single use product and should be disposed off after it is saturated or exhausted. Testing results demonstrate that the product used in the present invention has very high capacity and is stable in water. These products are made mixing the respective metal salts or oxides (from 5-95% by weight) with the binder (balance) followed by forming it by extrusion or other forming methods commonly known into desired particle size. Alternately, these products can also be formed by impregnation method where a metal salt solution is impregnated on a formed media such as alumina or clay. These formed materials are dried followed by reduction to sulfided metals by treatment with any of the sulfidation techniques and chemicals. The formed metal sulfides have a very high surface area and can have shapes including granules, beads, or other shapes.

The formed sulfided metals can be used in a column system. The column system generally comprises of one or more columns in a series configuration as Lead-Lag1-Lag2-Polisher. When the lead column is exhausted it is removed from the system and Lag-1 becomes the lead column followed by addition of a new column at the end as a polisher. These products can also be used in other water treatment unit systems where contact between contaminated water and the formed product can be achieved including batch reactor, plug flow reactor, continuous stirred treatment reactor and in any type of filtration system such as multimedia filtration system.

Preliminary studies were performed by mixing the adsorbent with simulated stripped sour water containing selenocyanate and other competing anions in an Erlenmeyer flask. The ratio of liquid: solid was maintained at 500:1. The dosage of adsorbent was 2 g/L for the initial evaluation. These flasks were kept on a shaker at constant temperature for 72 hours. After this equilibrium duration the solution was filtered through a 0.2 micron filter and analyzed for selenium concentration. Adsorbent efficiency was determined by distribution coefficient, Kd which is defined as follows: Kd=(C0-Cf) V/Cf·M where V=volume of solution of contaminant used for testing; mL C0 and Cf=Initial and Final concentration of contaminant respectively; μg/L M=mass of adsorbent used for testing; g. Kd=distribution coefficient; mL/g.

Products exhibiting a distribution coefficient (Kd) of greater than 4000 mL/g were evaluated further. Adsorption isotherms were developed for promising products which included metal sulfides. The equilibrium adsorption isotherm studies were conducted by mixing known dosage of adsorbent (0.5 g/L to 15 g/L) with simulated stripped sour water containing selenocyanate. After the treatment the solutions were filtered and the residual concentration of selenium was measured in the filtrate. The data clearly exhibits that nickel sulfide based products had good capacity for removal of selenocyanate from stripped sour water as compared to other products that were considered.

TABLE
Evaluation of products for Selenocyanate removal

| Material | Kd, mL/g |
|---|---|
| Chelating resin with sulfur | 4,722 |
| SAAMS with sulfur | 142 |
| SBA resin | 9,763 |
| WBA resin | 438 |
| Iron Powder 1-3micron | 461 |
| Titania based product | 130 |
| FeOOH | −22 |
| Nickel based product | 64 |
| Sulfided Ni based product | 68,431 |
| Cu based product | 35 |
| Sulfided Cu based product | 8,552 |
| Granular Activated Carbon (GAC) | 157 |
| Sulfur containing GAC | 263 |

### Specific Embodiments

While the following is described in conjunction with specific embodiments, it will be understood that this description is intended to illustrate and not limit the scope of the preceding description and the appended claims.

A first embodiment of the invention is a process for removing selenocyanate from an aqueous stream, comprising contacting the aqueous stream with an adsorbent comprising a bound sulfided metal. An embodiment of the invention is one, any or all of prior embodiments in this paragraph up through the first embodiment in this paragraph wherein the metal in the bound sulfided metal is selected from the group consisting of nickel, copper, cobalt, iron, manganese, zinc and mixtures thereof. An embodiment of the invention is one, any or all of prior embodiments in this paragraph up through the first embodiment in this paragraph wherein the metal in the bound sulfided metal comprises between 5 and 95 wt % of the bound sulfided metal. An embodiment of the invention is one, any or all of prior embodiments in this paragraph up through the first embodiment in this paragraph wherein the bound sulfided metal comprises from 5-75 wt % sulfur. An embodiment of the invention is one, any or all of prior embodiments in this paragraph up through the first embodiment in this paragraph wherein the metal comprises nickel. An embodiment of the invention is one, any or all of prior embodiments in this paragraph up through the first embodiment in this paragraph wherein the metal comprises copper. An embodiment of the invention is one, any or all of prior embodiments in this paragraph up through the first embodiment in this paragraph wherein the bound sulfided metal comprises a binder selected from the group consisting of alumina, silica, clay, organic binders and metal oxides. An embodiment of the invention is one, any or all of prior embodiments in this paragraph up through the first embodiment in this paragraph wherein the contacting of the aqueous stream with the bound sulfided metal is by mixing the aqueous stream with the bound sulfided metal. An embodiment of the invention is one, any or all of prior embodiments in this paragraph up through the first embodiment in this paragraph wherein the aqueous stream is passed through at least one column containing the bound sulfided metal. An embodiment of the invention is one, any or all of prior embodiments in this paragraph up through the first embodiment in this paragraph wherein the at least one column comprise a lead column, a first lag column, a second lag column and a polishing column.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for removing selenocyanate from an aqueous stream, comprising contacting the aqueous stream with an adsorbent comprising a bound sulfided metal or a powdered sulfided metal to remove selenocyanate wherein the process is without heating the aqueous stream and without adjustment of pH of the aqueous stream.

2. The process of claim 1 wherein the metal in the bound sulfided metal or the powdered sulfided metal is selected from the group consisting of nickel, copper, cobalt, iron, manganese, zinc and mixtures thereof.

3. The process of claim 1 wherein the metal in the bound sulfided metal comprises between 5 and 95 wt % of the bound sulfided metal.

4. The process of claim 1 wherein said bound sulfided metal comprises from 5-75 wt % sulfur.

5. The process of claim 2 wherein said metal comprises nickel.

6. The process of claim 2 wherein said metal comprises copper.

7. The process of claim 1 wherein said bound sulfided metal or a powdered sulfided metal comprises a mixture of metal sulfides.

8. The process of claim 1 wherein said bound sulfided metal comprises a binder selected from the group consisting of alumina, silica, clay, organic binders and metal oxides.

9. The process of claim 1 wherein said contacting of said aqueous stream with said bound sulfided metal is by mixing said aqueous stream with said bound sulfided metal.

10. The process of claim 1 wherein said aqueous stream is passed through at least one column containing said bound sulfided metal.

11. The process of claim 10 wherein the at least one column comprise four columns comprising a lead column, a first lag column, a second lag column and a polishing column.
